(19) United States
(12) Patent Application Publication
(10) Pub. No.: US 2018/0282917 A1
(43) Pub. Date: Oct. 4, 2018

(54) Non-woven graphene fiber fabric and preparing method thereof

(71) Applicant: ZHEJIANG UNIVERSITY, Hangzhou ,Zhejiang (CN)

(72) Inventors: Chao GAO, Hangzhou,Zhejiang (CN); Zheng LI, Hangzhou-Zhejiang (CN)

(73) Assignee: ZHEJIANG UNIVERSITY

(21) Appl. No.: 15/576,601

(22) PCT Filed: Mar. 28, 2017
(86) PCT No.: PCT/CN2017/078393

§ 371 Date: Nov. 22, 2017

(30) Foreign Application Priority Data
Jul. 18, 2016 (CN) 2016105680520.8

(51) Int. Cl. D04H 1/4242; D04H 1/724; D01F 11/10; D01F 9/12

(52) U.S. Cl. CPC D04H 1/4242; D04H 1/724; C01B 32/182; D01F 9/12; D01F 11/10

(57) ABSTRACT

A non-woven graphene fiber fabric and a preparing method therefor is provided. The non-woven fabric is formed by disorderly piled graphene fibers which are bonded with each other. The fibers are overlapped into a permeable network for passing through light, liquid or gas. The non-woven graphene fiber fabric is completely formed by graphene fibers without polymeric materials serving as skeleton or adhesive, and has good mechanical strength and flexibility. After reduction, the network structure built by the graphene fibers has excellent electrical and thermal conductivity and can be utilized as a high-performance fabric with multiple functions.

### CROSS REFERENCE OF RELATED APPLICATION

This is a U.S. National Stage under 35 U.S.C 371 of the International Application PCT/CN2017/078393, filed Mar. 28, 2017, which claims priority under 35 U.S.C. 119(a-d) to CN 201610568052.8, filed Jul. 18, 2016.

### BACKGROUND OF THE PRESENT INVENTION

### Field of Invention

The present invention relates to a graphene fabric, and more particularly to a non-woven graphene fiber fabric and a preparing method therefor.

### Description of Related Arts

Graphene, which is an allotrope of carbon with a thickness of a single atom, has the highest strength, thermal conductivity and charge carrier mobility in known materials. Therefore, graphene has attracted great interests since the report by Geim and et al. in 2004 (Science, 2004, 306: 666-669). Graphene fiber, which is a one-dimensional macroscopic assembled structure of two-dimensional graphene sheets, has outstanding strength, high electrical and thermal conductivity, and many other charming properties. Because of the excellent performance of graphene, such fibrous material in macroscopic scale exhibits great potential in various areas. One of the strategies to further apply graphene fibers in practical application is to make fabrics of them in order to obtain flexible, highly electrically and thermally conductive functional fabrics.

On the other hand, the addition of graphene to non-graphene fabrics is capable of improving the performance of the fabrics, e.g., soaking and coating graphene oxide solution on a skeleton of a polymer fiber fabric, and then reducing the graphene oxide to obtain a graphene coating (Carbon, 2010, 48 (12): 3340-3345); or adding the graphene to polymer fibers to prepare composite fibers (Macromolecules, 2010, 43(16): 6716-6723), and then further preparing fabrics. The fabrics prepared by the method mentioned above have improved properties to a certain extent, however, these fabrics are hardly called the real graphene fabrics due to the low content of graphene. Therefore these fabrics are usually of limited performance in electrical and thermal conductivities. At present, fabrics made of neat graphene fibers are not reported.

### SUMMARY OF THE PRESENT INVENTION

The conventional graphene modified fabrics have limited performance in their practical use because of the small content of graphene. In view of the problems mentioned above, the present invention provides a non-woven fabric made of pure graphene fibers and a preparing method therefor.

The present invention is implemented by the following technical solutions. A non-woven graphene fiber fabric, wherein the non-woven graphene fiber fabric is formed by overlapping graphene fibers with a diameter at a range of 1-1000 μm to form a network structure; wherein the graphene fibers on nodes of the network are merged with each other; and the graphene fibers are formed by highly aligned graphene sheets along the axial direction.

Furthermore, a diameter of the graphene fiber is at a range of 1-100 μm.

A method for preparing the non-woven graphene fiber fabric comprises following steps of:

(1) preparing graphene oxide dispersion with a concentration at a range of 1-15 mg/mL, wherein a solvent of the graphene oxide dispersion is N, N′-dimethyl formamide, and the graphene oxide dispersion serves as a spinning solution;

(2) extruding the spinning solution at a velocity range of 0.01-10 mL/min through a spinneret with a diameter at a range of 10-1000 μm to enter a coagulation bath, soaking in the coagulation bath for 30-200 minutes to solidify the fibers, collecting the fibers by vacuum filtration, and make them staying at a room temperature for 5-30 hours and vacuum drying at 60° C. to obtain a film formed by graphene oxide fibers;

(3) dispersing the film obtained in the step (2) in a mixture of water and ethanol to obtain a suspension of the graphene oxide fibers, depositing the graphene oxide fibers by a strainer mesh to obtain a non-woven graphene oxide fiber fabric, washing the non-woven graphene oxide fiber fabric with ethanol for three times, and drying at 80° C.;

(4) reducing the non-woven graphene oxide fiber fabric to obtain the non-woven graphene fiber fabric.

Furthermore, the coagulation bath is ethyl acetate.

Furthermore, the coagulation bath is put in a cylindrical container which is rotatable and a length of the graphene fiber is over 2 mm by controlling a ratio of a rotating rate of the cylindrical container to an extrusion velocity of the spinning solution.

Furthermore, in the mixture of the water and the ethanol for dispersing the film to obtain a suspension of the graphene oxide fibers in the step (3), a volume ratio of the water to the ethanol is at a range of 3:1-1:3.

Furthermore, the strainer mesh in the step (3) is a microporous membrane, a gauze or a stainless steel wire mesh which have an aperture at a range of 0.2-100 μm.

Furthermore, a reducing method in the step (4) is by utilizing a chemical reducing agent of hydroiodic acid, hydrazine hydrate, vitamin C or sodium borohydride for chemical reduction; or by a thermal reduction at a temperature range of 100-3000° C.

Compared with the conventional arts, the present invention has beneficial effects as follows.

(1) The nonwoven graphene fiber fabric is entirely formed by graphene fibers, without addition of poorly conductive materials such as polymers. By utilizing the graphene fibers with aligned graphene sheets and realizing interfusing between graphene fibers, a robust and conductive network is formed. As a result, the nonwoven graphene fiber fabric has outstanding electrical and thermal conductivity and other functional properties and thus has a wide range of applications.

(2) By the method of wet-spinning, short graphene fibers could be obtained continuously, and non-woven graphene fiber fabric is thus formed, the method is simple and easy for large-scale preparation.

(3) The structure and properties of the prepared non-woven graphene fiber fabric can be controlled by regulating the diameter and length of the graphene fibers.

(4) The non-woven graphene fiber fabric has good strength and flexibility.

### BRIEF DESCRIPTION OF THE DRAWINGS

FIG. 1 is a scanning electron micrograph of a typical non-woven graphene fiber fabric, indicating that the microstructure of the fabric is formed by disorderly packed graphene fibers.

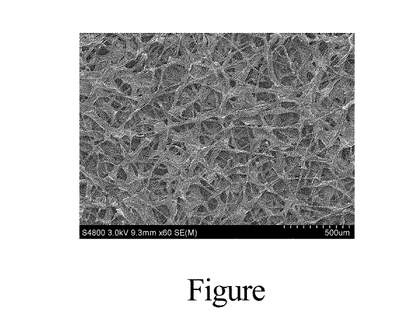

### DETAILED DESCRIPTION OF THE PREFERRED EMBODIMENT

The present invention discloses a non-woven graphene fiber fabric, wherein the non-woven fabric is a network structure made by graphene fibers which are overlapped with each other to form a network structure; wherein the graphene fibers are formed by aligning graphene sheets in an axial direction; wherein the graphene fibers are bonded and merged between each other in a certain degree, which greatly enhances interactions between the graphene fibers. Compared with the conventional polymer-containing graphene modified fabrics, the present invention significantly improves performances of the fabric in electrical conductivity, thermal conductivity and etc.

In order to construct a non-woven fabric with a network structure composed only of graphene, the present invention provides an effective strategy to obtain an interfused graphene fiber fabric. The re-dispersing process (step (3)) is employed to disperse the graphene fibers in the solution again, and meanwhile the amount of solvent in the fibers is greatly reduced as compared with the as-spun ones, so that the volume shrinkage during drying of the graphene fibers is significantly decreased, in such a manner that the structure of the non-woven graphene fiber fabric can be maintained, which solves the technical problems that the non-woven fabric cannot be formed by directly removing the solvent. The finally obtained non-woven graphene fiber fabric has characters of low density, high porosity and high specific surface area. In addition, the graphene oxide fibers which are dispersed again in step (3) are swelled, thus the fibers could be merged on nodes where the fibers contact with each other. There is no longer weak interaction among the fibers, and stronger π-π interactions are provided. Meanwhile, after the fibers are merged, an integrated and robust network is formed, which avoids the energy loss caused by the weak connection between fibers, and thus better electrical and thermal conductivity are achieved.

Based on the characteristics mentioned above, the non-woven graphene fiber fabric of the present invention is hopefully applied in the catalysis and energy fields as conductive frameworks, electrodes, separators and etc.

It is worth mentioning that in the re-dispersion process mentioned above, the applied solvent, i.e. the mixture of water and ethanol, is strictly optimized. After a large number of experiments, it has been found that if a proportion of the water is too large, shrinkage is serious while drying, and the non-woven fabric is not capable of being obtained; if a proportion of the ethanol is too large, the graphene oxide fiber film obtained in the step (2) is not capable of achieving dispersing again. That may because the affinity between the graphene oxide and the water makes the graphene oxide fibers dried and aggregated in the step (2) swollen, so as to disperse again. The effect of ethanol is to suppress excessive water absorbing and swelling of the fibers to avoid excessive shrink. Thus, the volume ratio of the water to the ethanol is determined at a range of 3:1-1:3.

Further description of the present invention is illustrated in detail in the preferred embodiments as follows. One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the present invention.

### Example 1

(1) preparing graphene oxide dispersion with a concentration of 5 mg/mL, wherein a solvent of the graphene oxide dispersion is N, N′-dimethyl formamide, and the graphene oxide dispersion serves as a spinning solution;

(2) extruding the spinning solution at a velocity of 0.04 mL/min through a spinneret with a diameter of 100 μm to enter a coagulation bath of ethyl acetate, wherein a rotating rate of the coagulation bath is controlled at 100 rpm, so as to keep a length of the graphene short fiber at a range of 20-40 mm, soaking in the coagulation bath for 30 minutes to solidify the fibers, collecting the fibers by vacuum filtration, and make them staying at a room temperature for 5 hours and vacuum drying at 60° C. for 3 hours to obtain a film formed by graphene oxide fibers;

(3) dispersing the graphene oxide film dried in the step (2) in a mixture of water and ethanol to obtain a suspension of the graphene oxide fibers; wherein a volume ratio of the water to the ethanol is shown in Table. 1; and an optimum volume ratio is water:ethanol=3:1; in such a manner that a suspension of short graphene oxide fibers is obtained, depositing the graphene oxide fibers by a strainer mesh with an aperture of 500 μm, washing with ethanol for three times, and drying at 80° C. for 10 hours to obtain a non-woven graphene oxide fiber fabric;

(4) annealing the non-woven graphene oxide fiber fabric under 3000° C. to obtain the non-woven graphene fiber fabric.

By the steps mentioned above, the microstructure of the non-woven graphene fiber fabric is randomly stacked graphene short fiber, wherein the short fiber is in a shape of a belt which has a width of 10-30 μm. A density of the non-woven fabric is about 0.22 mg/cm³, an overall tensile strength of 0.5-1.0 MPa, a breaking elongation is at a range of 3.5% to 5%, with good toughness, and conductivity is at a range of 25000-30000 S/m.

TABLE 1
Effects of volume ratio of water to ethanol on preparation of the non-woven graphene fiber fabric

| Water:ethanol | 4:1 | 3:1 | 2:1 | 1:1 | 1:2 | 1:3 | 1:4 |
|---|---|---|---|---|---|---|---|
| Microstructure | The | The | Only a | The graphene | The graphene | The graphene | The graphene |
| of the non- | graphene | graphene | few fiber | oxide fibers | oxide fibers | oxide fibers | oxide fibers |
| woven fabric | fiber is | fiber is | junctions | obtained | obtained | obtained | obtained |
| | almost | only | are | in the step | in the step | in the step | in the step |
| | completely | merged on | merged. | (2) are | (2) are | (2) are | (2) fail to |
| | merged. | the fiber | | difficult to | difficult to | difficult to | disperse again. |
| | | junction. | | disperse again. | disperse again. | disperse again. | The non-woven |
| | | | | The graphene | The graphene | The graphene | graphene |
| | | | | fibers of | fibers of | fibers of | fiber fabric |
| | | | | the non-woven | the non-woven | the non-woven | cannot be |
| | | | | fabric fail | fabric fail | fabric fail | obtained. |
| | | | | to interfuse. | to interfuse. | to interfuse. | |
| Density | ~1 | ~0.22 | ~0.20 | ~0.18 | ~0.19 | ~0.17 | — |
| | mg/cm³ | mg/cm³ | mg/cm³ | mg/cm³ | mg/cm³ | mg/cm³ | |
| Macroscopic | Small | Moderate | Large | The non-woven | The non-woven | The non-woven | — |
| shape of | porosity, | porosity, | porosity, | fabric is | fabric is | fabric is | |
| the non- | light- | photoper- | photoper- | loose in | loose in | loose in | |
| woven fabric | proof. | meability. | meability. | structure | structure | structure | |
| | | | | and has | and has | and has | |
| | | | | photoper- | photoper- | photoper- | |
| | | | | meability. | meability. | meability. | |

### Example 2

(1) preparing graphene oxide dispersion with a concentration of 6 mg/mL, wherein a solvent of the graphene oxide dispersion is N, N′-dimethyl formamide, and the graphene oxide dispersion serves as a spinning solution;

(2) extruding the spinning solution at a velocity of 0.06 mL/min through a spinneret with a diameter of 200 μm to enter a coagulation bath of ethyl acetate, wherein a rotating rate of the coagulation bath is controlled at 120 rpm, so as to keep a length of the graphene short fiber at a range of 20-40 mm, soaking in the coagulation bath for 200 minutes to solidify the fibers, collecting the fibers by vacuum filtration, and make them staying at a room temperature for 30 hours and vacuum drying at 60° C. for 3 hours to obtain a film formed by graphene oxide fibers;

(3) dispersing the graphene oxide film dried in the step (2) in a mixture of water and ethanol to obtain a suspension of the graphene oxide fibers, wherein a volume ratio of the water to the ethanol is 1:2; in such a manner that a suspension of short graphene oxide fibers is obtained, depositing the graphene oxide fibers by a strainer mesh with an aperture of 500 μm, washing with ethanol for three times, and drying at 80° C. for 24 hours to obtain a non-woven graphene oxide fiber fabric;

(4) annealing the non-woven graphene oxide fiber fabric under 3000° C. to obtain the non-woven graphene fiber fabric.

By the steps mentioned above, the microstructure of the non-woven graphene fiber fabric is randomly stacked graphene short fiber, wherein the short fiber is in a shape of a belt which has a width of 40-100 μm. A density of the non-woven fabric is about 0.20 mg/cm³, an overall tensile strength of 0.2-0.3 MPa, a breaking elongation is at a range of 15% to 20%, with good toughness, and conductivity is at a range of 10000-13000 S/m.

### Example 3

Step (1) in the Example 3 is identical to the example 1.

Step (2): extruding the spinning solution at a velocity of 0.06 mL/min through a spinneret with a diameter of 200 μm to enter a coagulation bath of ethyl acetate, wherein a rotating rate of the coagulation bath is controlled at 120 rpm, so as to keep a length of the graphene short fiber at a range of 20-40 mm, soaking in the coagulation bath for 200 minutes to solidify the fibers, collecting the fibers by vacuum filtration, and make them staying at a room temperature for 30 hours and vacuum drying at 60° C. for 3 hours to obtain a film formed by graphene oxide fibers.

Steps (3) and (4) are identical to the steps (3) and (4) in the Example 1.

By the steps mentioned above, a width of the non-woven graphene fiber fabric is at a range of 60-200 μm. A density of the non-woven fabric is about 0.21 mg/cm³, an overall tensile strength of 0.7-0.9 MPa, a breaking elongation is at a range of 2.2% to 3.5%, with good toughness, and conductivity is at a range of 8000-12000 S/m.

### Example 4

Steps 1-3 are identical to the Example 1, step (4) is: reducing the non-woven graphene fiber fabric by hydroiodic acid. A density of the non-woven fabric is about 0.25 mg/cm³, an overall tensile strength of 0.5-1 MPa, a breaking elongation is at a range of 1.5% to 2%, and conductivity is at a range of 250-300 S/m.

### Example 5

(1) preparing graphene oxide dispersion with a concentration of 1 mg/mL, wherein a solvent of the graphene oxide dispersion is N, N′-dimethyl formamide, and the graphene oxide dispersion serves as a spinning solution;

(2) extruding the spinning solution at a velocity of 0.01 mL/min through a spinneret with a diameter of 10 μm to enter a coagulation bath of ethyl acetate, wherein a rotating rate of the coagulation bath is controlled at 100 rpm, so as to keep a length of the graphene short fiber at a range of 20-40 mm, soaking in the coagulation bath for 200 minutes to solidify the fibers, collecting the fibers by vacuum filtration, and make them staying at a room temperature for 5 hours and vacuum drying at 60° C. for 3 hours to obtain a film formed by graphene oxide fibers;

(3) dispersing the film obtained in the step (2) in a mixture of water and ethanol to obtain a suspension of the graphene oxide fibers, wherein a volume ratio of the water to the ethanol is 3:1; depositing the graphene oxide fibers by a gauze to obtain a non-woven graphene oxide fiber fabric on the gauze, washing the non-woven graphene oxide fiber fabric with ethanol for three times, and drying at 80° C.;

(4) annealing the non-woven graphene oxide fiber fabric under 3000° C. to obtain the non-woven graphene fiber fabric.

### Example 6

(1) preparing graphene oxide dispersion with a concentration of 15 mg/mL, wherein a solvent of the graphene oxide dispersion is N, N′-dimethyl formamide, and the graphene oxide dispersion serves as a spinning solution;

(2) extruding the spinning solution at a velocity of 0.1 mL/min through a spinneret with a diameter of 100 μm to enter a coagulation bath of ethyl acetate, wherein a rotating rate of the coagulation bath is controlled at 220 rpm, so as to keep a length of the graphene short fiber at a range of 20-40 mm, soaking in the coagulation bath for 200 minutes to solidify the fibers, collecting the fibers by vacuum filtration, and make them staying at a room temperature for 5 hours and vacuum drying at 60° C. to obtain a film formed by graphene oxide fibers;

(3) dispersing the film obtained in the step (2) in a mixture of water and ethanol to obtain a suspension of the graphene oxide fibers, wherein a volume ratio of the water to the ethanol is 3:1; depositing the graphene oxide fibers by a gauze to obtain a non-woven graphene oxide fiber fabric on the gauze, washing the non-woven graphene oxide fiber fabric with ethanol for three times, and drying at 80° C.;

(4) annealing the non-woven graphene oxide fiber fabric under 3000° C. to obtain the non-woven graphene fiber fabric.

What is claimed is:

1. A non-woven graphene fiber fabric, wherein the non-woven graphene fiber fabric is formed by overlapping graphene fibers with a diameter at a range of 1-1000 μm to form a network structure; wherein the graphene fibers on nodes of the network are merged with each other; and the graphene fibers are formed by highly aligned graphene sheets along the axial direction.

2. The non-woven graphene fiber fabric, as recited in claim 1, wherein a diameter of the graphene fiber is at a range of 1-100 μm.

3. A method for preparing the non-woven graphene fiber fabric as recited in claim 1, comprising following steps of:
(1) preparing graphene oxide dispersion with a concentration at a range of 1-15 mg/mL, wherein a solvent of the graphene oxide dispersion is N, N′-dimethyl formamide, and the graphene oxide dispersion serves as a spinning solution;
(2) extruding the spinning solution at a velocity range of 0.01-10 mL/min through a spinneret with a diameter at a range of 10-1000 μm to enter a coagulation bath, soaking in the coagulation bath for 30-200 minutes to solidify the fibers, collecting the fibers by vacuum filtration, and make them staying at a room temperature for 5-30 hours and vacuum drying at 60° C. to obtain a film formed by graphene oxide fibers;
(3) dispersing the film obtained in the step (2) in a mixture of water and ethanol to obtain a suspension of the graphene oxide fibers, depositing the graphene oxide fibers by a strainer mesh to obtain a non-woven graphene oxide fiber fabric, washing the non-woven graphene oxide fiber fabric with ethanol for three times, and drying at 80° C.;
(4) reducing the non-woven graphene oxide fiber fabric to obtain the non-woven graphene fiber fabric.

4. The method for preparing the non-woven graphene fiber fabric as recited in claim 3, wherein the coagulation bath is ethyl acetate.

5. The method for preparing the non-woven graphene fiber fabric as recited in claim 3, wherein the coagulation bath is put in a cylindrical container which is rotatable and a length of the graphene fiber is over 2 mm by controlling a ratio of a rotating rate of the cylindrical container to an extrusion velocity of the spinning solution.

6. The method for preparing the non-woven graphene fiber fabric as recited in claim 3, wherein in the mixture of the water and the ethanol for dispersing the film to obtain a suspension of the graphene oxide fibers in the step (3), a volume ratio of the water to the ethanol is at a range of 3:1-1:3.

7. The method for preparing the non-woven graphene fiber fabric as recited in claim 3, wherein the strainer mesh in the step (3) is a microporous membrane, gauze or a stainless steel wire mesh which have an aperture at a range of 0.2-100 μm.

8. The method for preparing the non-woven graphene fiber fabric as recited in claim 3, wherein a reducing method in the step (4) is by utilizing a chemical reducing agent of hydroiodic acid, hydrazine hydrate, vitamin C or sodium borohydride for chemical reduction; or by a thermal reduction at a temperature range of 100-3000° C.
